(19) United States
(12) Patent Application Publication
(10) Pub. No.: US 2008/0016168 A1
(43) Pub. Date: Jan. 17, 2008

(54) Email Routing System

(75) Inventors: Mark J. Noonan, Boyertown, PA (US); Julianne Noonan, Boyertown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/776,752

(22) Filed: Jul. 12, 2007

Related U.S. Application Data
(60) Provisional application No. 60/807,209, filed on Jul. 13, 2006.

(51) Int. Cl. G06F 15/16

(52) U.S. Cl. 709/206

(57) ABSTRACT

An electronic mail processing system is capable of receiving an electronic mail message intended for at least one recipient. Such a system includes an interface engine for receiving the electronic mail message. The system further includes an executable application adapted to parse information contained within the electronic mail message, and to apply conditional logic to the parsed information in order to identify a desired additional destination for the electronic mail message other than the original recipient.

This application derives priority from Provisional Patent Application Ser. No. 60/807,209, filed on Jul. 13, 2006.

### FIELD OF THE INVENTION

The present invention relates generally to the field of data processing, and more specifically to the reading, reformatting and routing of electronic mail.

### BACKGROUND OF THE INVENTION

Large organizations, such as e.g. health care facilities, communicate vast amounts of data in many differing data formats. The data is often useful to many different computer systems and applications that communicate via various interfaces and protocols. One common method of communicating data is by means of electronic mail (e-mail), which can be interchanged with many personal wireless devices and computers. The data contained in an e-mail may be intended for, or useful to, the users of numerous disparate computer systems that are configured to receive data in differing formats. For example, an emergency room (ER) admission clerk may, during a busy period, walk through the ER waiting room with a wireless handheld device. Using a preset template, he or she can obtain the patient information required for admission. The admission information is then e-mailed in a particular format to an admission system that is capable of receiving data in that format. Yet the admission information may also be useful to numerous other hospital computer systems that may be incapable of receiving data in the format in which the e-mail was generated or which can only receive information via a communications protocol that is not available to the wireless handheld device.

There is currently no centralized communication device that may operate between interfaced processing systems that allows for the routing of information contained within an electronic mail message, such as admission or other data, to distinct, disparate systems based upon the information contained within the e-mail. Existing data processing systems typically have limited email routing flexibility and adaptability. A need exists for a system which allows reformatting of emailed data to match the communications and data input needs of each particular receiving system. An e-mail routing system constructed according to the principles of the present invention addresses these issues and related problems.

### BRIEF SUMMARY OF THE INVENTION

In accordance with principles of the present invention, an electronic mail processing system is capable of receiving an electronic mail message intended for at least one recipient. Such a system includes an interface engine for receiving the electronic mail message. The system further includes an executable application adapted to parse information contained within the electronic mail message, and to apply conditional logic to the parsed information in order to identify a desired additional destination for the electronic mail message other than the original recipient.

### BRIEF DESCRIPTION OF THE DRAWING

In the drawing:

FIG. 1 is block diagram illustrating an e-mail routing system constructed according to the principles of the present invention;

FIG. 2 is a flow chart illustrating the data flow within the e-mail routing system depicted in FIG. 1 according to the present invention; and

FIG. 3 and FIG. 4 are a pictorial diagrams illustrating respective portions of a graphical user interface available to a user of the e-mail routing system depicted for example in FIG. 1 according to the present invention.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, an e-mail routing system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. A graphical user interface (GUI) uses graphical display images, as opposed to textual display images, when generating the UI. A form, as used herein, is a type of UI display image. A form UI display image includes display elements, such as textual display, which prompt the user to enter particular information; and display elements, such as text boxes, check boxes etc., into which the user, using the input devices, may enter the particular information.

An electronic mail processing system is capable of receiving an electronic mail (e-mail) message intended for at least one recipient. The e-mail message contains information representing at least one data item. An interface engine receives and processes the electronic mail message. An executable application is adapted to parse information contained within the electronic mail message. The executable application further applies conditional logic to the parsed information in order to identify an additional destination for the electronic mail message other than the original recipient. The additional destination may be (1) other e-mail recipients, (2) other systems without capability to receive e-mail, and/or (3) other systems with the capability to receive e-mail. The executable application reroutes the information contained within the electronic mail message to the identified additional destination or destinations.

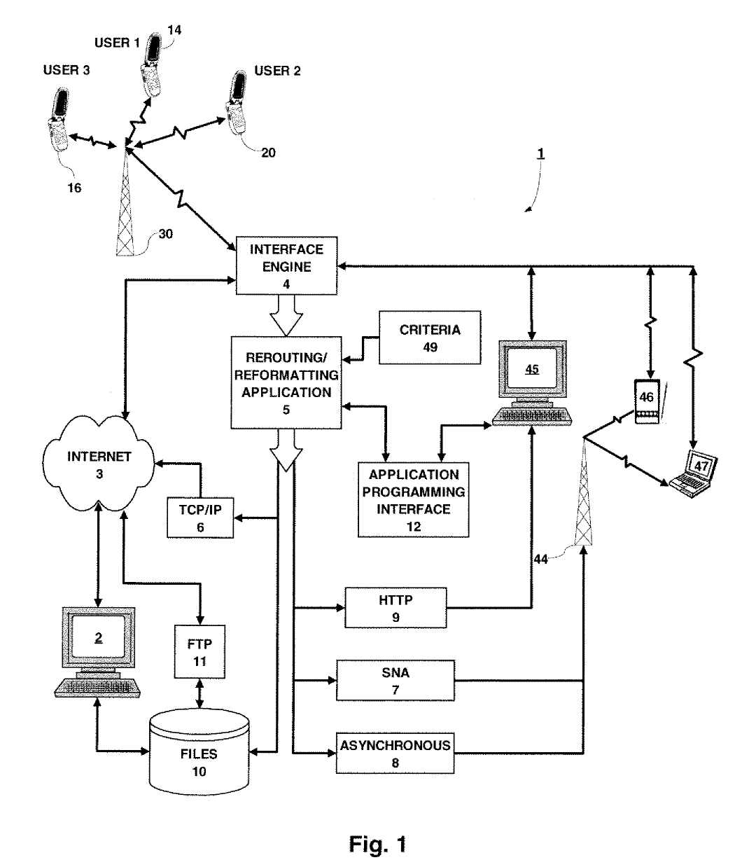

Referring to FIG. 1, an embodiment 1 of an e-mail routing system is illustrated. The system 1 is adapted to receive electronic mail (e-mail) from a variety of sources. For example, individual users, USER1, USER 2, and USER3, having access to handheld wireless devices 14, 16 and 20 respectively, are capable of generating e-mail messages. The handheld wireless devices may operate as a part of a dedicated communications network within e.g. a healthcare facility. Alternatively, the devices may be generic handheld communications devices such as cellular telephones operating via a publicly available cell phone network having a retransmitting or signal replicating facility, illustrated as antenna 30. The system 1 may also receive e-mail generated by a personal digital assistant device 46 operating over a wireless link, a portable personal computer 47 operating over a wireless link, or a computer 45 transmitting data via a cable or other hard wired interconnection. Additional computers, e.g. 2, may also send or receive e-mail messages via the internet 3. Each e-mail generating device is typically capable of both sending and receiving an e-mail message.

Regardless of the manner in which an e-mail message is received by the system 1, the message is received by an interface engine 4. An interface engine as used herein and in the claims exchanges data between different computer systems using different communication protocols and message data formats. The interface engine 4 may be implemented in a computer system containing a data storage capability and a processor. The interface engine 4 is adapted to receive and process e-mails in a variety of formats from any of the numerous e-mail sources, described above, that have access to the system 1.

Once an e-mail is received, that e-mail is supplied to a rerouting and reformatting executable application 5. The rerouting and reformatting executable application 5 parses the information contained within the e-mail message. The parsed information is processed by conditional logic defined by data stored in a criteria source 49. That is, the rerouting and reformatting executable application 5 applies a plurality of individual conditional logic statements stored in the criteria source 49 to at least one data item within the e-mail message to determine at least an additional destination for the information contained within the e-mail message. Thus, the information contained within the e-mail message is rerouted based on the contents of the e-mail message in a manner controlled by the data stored in the criteria store 49.

Further information stored in the criteria source 49 associates the additional destination with at least: (a) a destination address, (b) a message format, and/or (c) a preferred mode of communications which is compatible with the additional destination. Thus, when an additional destination is determined for the information contained within the received e-mail message, the destination address, message format and preferred mode of communication for rerouting that information to the destination is also determined by the information stored in the criteria store 49.

Based on the processing by the conditional logic, the e-mail may be discarded or rerouted to a desired destination via wireless network, such as to the personal digital assistant device 46 or portable personal computer 47 via a wireless line illustrated by an antenna 44, or a computer 45 via a wired link. The rerouting and reformatting executable application 5 may also reroute the e-mail message to the users USER1, USER2, USER3 via the wireless link represented by the antenna 30, or to one or more personal computers 2 via the Internet 3.

Alternatively, the information contained within the e-mail message may be rerouted to the personal computer 45 via an application programming interface 12. That is, the executable application running on the personal computer 45 may request data directly from the rerouting and reformatting executable application 5 and the rerouting and reformatting executable application 5 may return data directly to the executable application running on the personal computer 45. Various methods for performing such transfers employ direct data exchange (DDE), object linking and embedding (OLE), a dynamic linked library (DLL), and so forth.

In addition, the information contained within the e-mail message may be stored in a file storage device 10. Such a storage device 10 may be made concurrently available to other processors, such as personal computer 2. The personal computer 2 may then retrieve the information contained in the e-mail message from the file storage device 10. Such file storage devices may be made available via a local area network (LAN) either as a part of a network server, or a standalone network attached storage (NAS) device. If such a storage device 10 is made available via the Internet 3, a file transfer protocol, e.g. FTP 11, may be used by the personal computer 2 to access and retrieve the information from the storage device 10 via the Internet 3.

In order to reroute the information in the e-mail message to the desired destination, the rerouting and reformatting executable application 5 accesses the data associated with the desired destination stored in the criteria store 49, As described above, this information includes data representing a communications mode that is compatible with a communications mode that can be processed by the destination. The system 1 may communicate with destinations which receive information via a variety of communications modes or network protocols. These communication modes include but are not limited to (a) transmission control protocol/internet protocol (TCP/IP) 6, (b) systems network architecture (SNA) 7, (c) asynchronous connections 8, (d) hyper text transfer protocol (HTTP) 9, and/or (e) through files 10 either locally or sent via the file transfer protocol (FTP) 11.

In general, the method for rerouting and reformatting an e-mail message includes receiving an e-mail message in a first format intended for a first destination by the interface engine 4. Information contained within the e-mail message is associated with a second destination. The rerouting and reformatting executable application 5 accesses the data associated with the second destination from the criteria store 49. As described above, this information includes a second format associated with the second destination. The compatibility of the information contained within the e-mail message is evaluated to determine compatibility of the first format with a receiving format desired by the second destination. The information contained within the e-mail message is reformatted into a second format that is compatible with the receiving format of the second destination. The reformatted information is then rerouted to the additional destination.

More specifically, based on the selected rerouting destination, the rerouting and reformatting executable application 5 may also reformat the e-mail based on system-wide pre-defined rules which are stored in an information storage medium 49. The rerouting and reformatting executable application 5 selects a message format that is compatible with a format that can be processed by the destination The rerouting and reformatting executable application 5 then reformats the information contained within the e-mail message into a format that is compatible with the format that can be processed by the destination. There are several formats which may be selected by the rerouting and reformatting executable application 5 including, but not limited to: (a) plain text, (b) hypertext markup language (HTML), (c) rich text format (RTF), (d) health level 7 (HL7) and/or (e) extensible markup language (XML) formats.

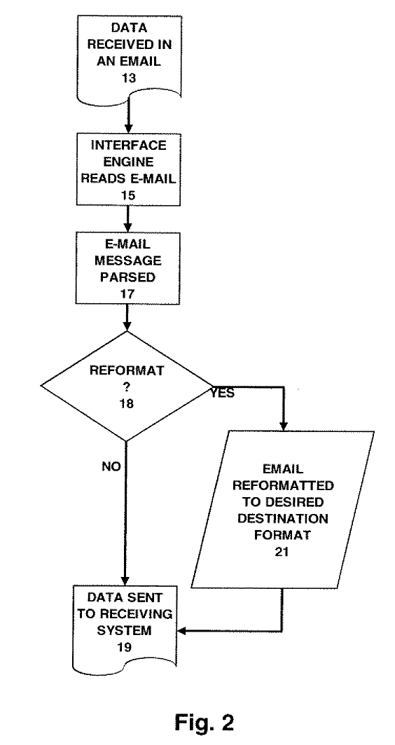

Referring also to FIG. 2, the data processing steps that are applied to an incoming e-mail may be better understood. One skilled in the art understands that the steps illustrated in FIG. 2 may be performed automatically, meaning without direct human intervention. Regardless of the source of the incoming e-mail, the data contained in the e-mail initially arrives at the interface engine 4 (FIG. 1) at step 13. The received e-mail is read by the rerouting and reformatting executable application 5 at step 15. As described above, the executable application includes a parsing function for parsing the information contained in the e-mail message at step 17. The parsing process creates a plurality of individual nodes representing items of data, and which include a start and end tag as well as text residing between the start and end tags. The respective nodes produced by the parsing function are examined for data that indicates a need to perform at least (a) reformatting, and/or (b) rerouting of the information contained within the e-mail message.

That is, the rerouting and reformatting executable application 5 applies the conditional logic from the criteria store 49 to the respective nodes generated by the parsing function. Based on the results of the application of the conditional logic to the respective nodes, the rerouting and reformatting executable application 5 identifies user specified criteria that are present within the e-mail message that permit the application to properly route the e-mail to a desired destination. More specifically, the rerouting and reformatting executable application 5 examines the individual respective nodes produced by the parsing function to determine an association between the e-mail message and a conditional logic statement indicating an additional destination for the information contained in the e-mail message.

The rerouting and reformatting executable application 5 (FIG. 1) reroutes the information contained within the e-mail message in response to the information contained within at least one node. That is, the rerouting and reformatting executable application 5 may reroute the information contained within the e-mail message in response to the information contained in a single node, or a plurality of nodes. In the event that the format of the received e-mail message does not match any specified criteria, the user of the system 1 is alerted and the message is discarded. In this case, steps are taken to alert the user as to the absence of a destination associated with the information contained within the message, and to discard the e-mail message.

Any portion of the e-mail message is available to be compared to the user defined criteria. For example, a routing criterion in the criteria store 49 (FIG. 1) may specify a marker within the e-mail message explicitly identifying the message as routine, priority or critical; or routing criteria may refer to the sender of the e-mail, the time that the e-mail was created, the presence of a particular word, phrase or numeral within the message, and/or the location of the device originating the e-mail. Depending on the user defined criteria, the application 5 reroutes the e-mail to one or more designated receiving systems.

Based on the application of the user defined criteria to the incoming e-mail message, the rerouting and reformatting executable application 5 (FIG. 1) decides at step 18 whether reformatting of the information contained within the e-mail is necessary in view of the message format expected by the designated receiving system. If reformatting is not necessary, the e-mail is sent in its original format at step 19 to the designated receiving system using the specific communications mode expected by the designated receiving system. If reformatting is necessary based on the designated receiving system, an executable procedure performs the reformatting process in the rerouting and reformatting executable application 5 at step 21. The reformatted information is sent to the designated receiving system in the required format in step 19.

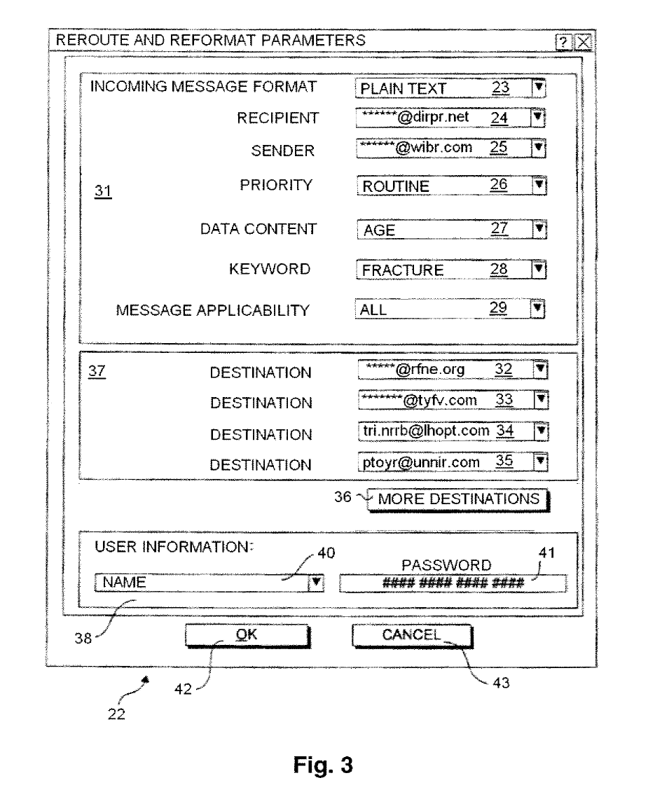

A user of the system 1 (FIG. 1) is permitted to define the conditional logic statements utilized by the rerouting and reformatting executable application 5 via a graphical user interface (GUI). The GUI form 22, illustrated in FIG. 3, permits the user to specify desired routing and reformatting parameters defining a criterion. User information is entered in region 38 of the GUI 22. The name of the user is entered in box 40 and the user password is entered in box 41. If the user is verified, access to the remainder of the form 22 is permitted.

Using the remainder of form 22, the user may set various components of a criterion. For example, the user is able to specify by means of the drop down menu 23 the incoming e-mail message format that is to be examined by the routing and reformatting executable application 5 (FIG. 1). Typically the drop down menu includes selections such as plain text format, hypertext markup language (HTML) and rich text format, as well as a selection labeled “ALL FORMATS”. The user may also specify a recipient or recipients of interest by means of drop down menu 24. The recipient selections appearing in menu 24 are typically any previously entered recipient. A selection entitled “ALL”, as well as any previously defined subgroups or lists of recipients that have been given a unique identifier are also provided. Similarly, the user may specify the examination of an e-mail based on the sender of the e-mail via drop down menu 25. The sender menu selections typically include previously entered senders, “ALL” and any previously defined groups or lists. Drop down menus 24 and 25 also provide a means to supply new recipients and/or senders, including patterns, sometimes called wildcards, for identifying a plurality of recipients and/or senders, such as using “*” to indicate any string of letters and/or numbers.

Some e-mails may be identified by a rating of importance or priority, and for those cases the drop down menu 26 includes choices such as “ALL”, “URGENT” and “ROUTINE”. E-mails may also be selected for reformatting and rerouting based on the content of particular data fields, which may defined by drop down menu 27. The data menu 27 may be used to select “ALL” as well as any other defined data fields such as “AGE”, “WEIGHT”, “GENDER” or “OUTPATIENT”, for example. A particular data field of interest may appear within an e-mail message even though the field is not specifically identified within the e-mail by its common name or label. Rather, an alphanumeric or other identifier may appear within the body of an e-mail that indicates the presence of the desired data field. The parsing function of the rerouting and reformatting executable application 5 (FIG. 1) may detect any such appearance of the data field and associated value specified by the data content drop down menu 27. More than one data field and associated value may be specified by the user via form 22.

A word or phrase may also be detected by the rerouting and reformatting executable application 5 (FIG. 1) in the e-mail message. Any such word or phrase, labeled a keyword, may be placed in box 28 of the GUI 22 to trigger the rerouting or reformatting executable application 5 to detect the specified keywords. It is further possible for more than one such keyword may be specified in the form 22.

The foregoing e-mail selection criteria may be applied to all, some or none of the received e-mails as specified via the drop down menu 29. In addition, e-mail groups or lists may be identified for application of the criteria according to message types previously used or defined by the user.

Once selection criteria have been specified in region 31 of the GUI 22, the destination for the selected message is defined in region 37. A series of drop down menus 32, 33, 34 and 35 permit the user to define respective specific e-mail addresses as the designated destination or destinations. Each drop down menu contains a list of previously designated recipients as well as groups or lists of potential predefined recipients. If additional identities of e-mail recipients are required, the “MORE DESTINATIONS” box 36 may be selected in order to activate an additional destination address box. Means may also be provided to enter a new address for the selected message.

Once parameters representing a user criterion have been specified in areas 31 and 37, the user may accept the defined e-mail selection and destination criteria by clicking button 42, or the user may cancel the information entered in GUI 22 without storing it by clicking button 43.

One or more criteria may be defined by the user using form 22. The rerouting and reformatting executable application 5 (FIG. 1) applies the parameters defined in the user defined criteria to received e-mails to select e-mails which are to be rerouted, and possibly reformatted. An e-mail is selected if it matches the parameters defined in section 31 of the user defined criterion. The selected e-mail is reformatted, if required, then the information contained in that e-mail is rerouted to the destinations defined in the corresponding section 37 of the user defined criterion.

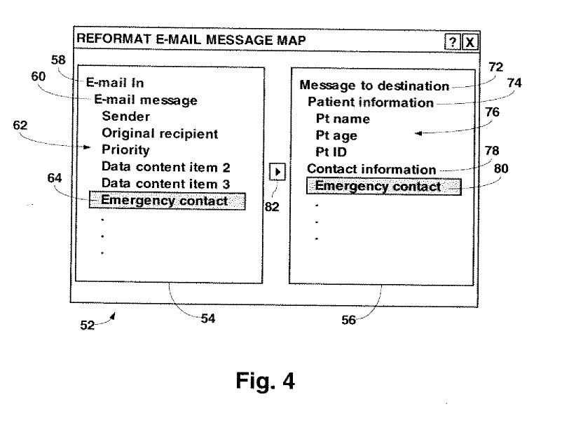

Further data may be defined by the user, and stored in criteria store 49 (FIG. 1), to map information from the received e-mail message to information to be placed in the reformatted and rerouted message. FIG. 4 illustrates a form 52 which the user may use to enter such mapping information. The form 52 includes a section 54 relating to the received e-mail message and a section 56 relating to the reformatted message to be rerouted to the additional destination. The received e-mail section 54 includes an entry 58 representing the received e-mail and an entry 60 representing the e-mail message. A further set 62 of entries represent information contained within the e-mail message, e.g. data content items and/or keyword items. For example, item 64 represents an emergency contact data content item contained within the received e-mail message.

The rerouted message represented in section 56 may, for example, be intended for a central database which stores patient information. Such an e-mail may be formatted to include a plurality of data items pertaining to the patient. These items are formatted in such a manner that they may be automatically parsed to extract the information and the extracted information automatically stored in the database. For example, the message represented by section 56 may be formatted in XML format containing tags corresponding to entries illustrated in section 56.

The rerouted message section 56 includes an entry 72 representing the message to be rerouted to the destination, an entry 74 representing patient information, and a plurality 76 of entries representing patient information data items. The rerouted message section 56 also includes an entry 78 representing contact information for the patient, and an entry 80 representing emergency contact information for the patient.

A user may map a data item from the received e-mail message to a data item in the message to be communicated to the additional destination by highlighting the entry representing that data item in the received e-mail section 54 and the matching entry in the rerouted message section 56. This is illustrated in FIG. 4 by a gray box around the emergency contact entry 64 in the received e-mail section 54 and a gray box around the emergency contact entry 80 in the rerouted message section 56. The user may then activate the match button 82. In response, the GUI stores information in the criteria store 49 (FIG. 1) indicating that emergency contact information detected in the incoming e-mail message should be mapped into an emergency contact data item in the reformatted and rerouted message sent to the additional destination—in this case the patent database.

In operation, the plurality of nodes resulting from the parsing function described above represent respective data items contained within the e-mail message. These nodes correspond to the entries in section 54. The rerouting and reformatting executable application 5 (FIG. 1) selects a message format (e.g. XML in the above example) that is compatible with a format that can be processed by the additional destination, also as described above. The selected format may contain entries representing data items. These data items correspond to the entries in section 56. The rerouting and reformatting executable application 5 reformats the information contained within the e-mail message to the selected message format, e.g. XML. During the reformatting operation, the rerouting and reformatting executable application 5 maps data items contained with the e-mail message (e.g. section 54) to data items in the selected message format (e.g. section 56) based on the data previously stored in the criteria store 49. The reformatted message is communicated to the additional destination using the selected communication mode.

As an example of the utility of the present system, the system 1 (FIG. 1) may be employed to receive e-mails at a health care facility via e.g. the internet 3. A patient scheduled for surgery, for example, might wish to change an already listed emergency contact telephone number. The patient sends an e-mail via any suitable e-mail device to the healthcare facility noting the change. The rerouting and reformatting executable application 5 in the system 1 reads the e-mail, uses parameters previously defined in section 31 of form 22 (FIG. 3) of a user criterion to identify the e-mail as containing an emergency contact telephone number which should properly be listed in several hospital system records which are not accessible to the e-mail sent in the original format used by the patient. The rerouting and reformatting executable application 5 in the system 1 determines the appropriate destinations for the information contained within the patient e-mail message based on the data previously entered in section 37 of form 22, reformats that information to a format compatible with the new destinations based on the data previously entered in sections 54 and 56 of form 52 (FIG. 4), selects the appropriate communications mode for sending the information to each new destination, and communicates the reformatted information to the appropriate recipient. In this manner the updated telephone number is automatically entered in the appropriate hospital system records without the need for human intervention in typing a series of e-mail messages and reentering the telephone number, thereby eliminating a potential point for the introduction of erroneous information.

The foregoing description of the preferred embodiment of the invention is not intended to be exhaustive but rather only illustrative of the invention as set forth in the claims.

What is claimed is:

1. An electronic mail processing system, capable of receiving an electronic mail message intended for at least one recipient, comprising:
an interface engine for receiving the electronic mail message; and
an executable application adapted to parse information contained within the electronic mail message, to apply conditional logic to the parsed information in order to identify an additional destination for the electronic mail message other than the original recipient, and to reroute the information contained within the electronic mail message to the identified additional destination.

2. The system according to claim 1, further comprising a graphical user interface permitting a user of the system to define the conditional logic utilized by the executable application.

3. The system according to claim 1, wherein the executable application further selects a message format that is compatible with a format that can be processed by the additional destination.

4. The system according to claim 3, wherein the executable application further reformats the information contained within electronic mail message into a format that is compatible with the format that can be processed by the additional destination.

5. The system according to claim 4, wherein the format selected by the executable application comprises at least one of: (a) plain text, (b) HTML, (c) RTF, (d) HL7, and (e) XML compatible format.

6. The system according to claim 1, wherein the executable application further selects a communications mode that is compatible with a communications mode that can be processed by the additional destination.

7. The system according to claim 6, wherein the communications mode selected by the executable application comprises at least one of: (a) TCP/IP, (b) SNA, (c) asynchronous connection, (d) HTTP, and (e) FTP compatible mode of communications.

8. The system according to claim 1, wherein the executable application further comprises a parsing function parsing the information contained in the electronic mail message into a plurality of nodes.

9. The system according to claim 8, wherein the executable application applies the conditional logic to the respective nodes generated by the parsing function.

10. The system according to claim 9, wherein the executable application reroutes the information contained within the electronic mail message in response to the information contained in at least one node.

11. The system according to claim 8, wherein:
the plurality of nodes represent respective data items contained within the electronic mail message;
the executable application selects a message format that is compatible with a format that can be processed by the additional destination and contains entries representing data items, and reformats the information contained within the electronic mail message to the selected message format; and
the executable application maps data items contained within the electronic mail message to data items in the selected message format.

12. An electronic mail rerouting and reformatting system, comprising:
an interface engine for receiving and processing individual electronic mail messages containing information comprising at least one data item; and
a rerouting and reformatting executable application for parses the information contained within the electronic mail message, applying a plurality of individual conditional logic statements to at least one data item within the electronic mail message to determine an additional destination for the information contained within electronic mail message, reformatting the information contained in the electronic mail to a format that can be processed by the additional destination, and rerouting the reformatted information to the additional destination.

13. The electronic mail rerouting and reformatting system of claim 12, comprising a source of information associating the additional destination with at least one of (a) a destination address, (b) a message format, and (c) a preferred mode of communication.

14. The electronic mail rerouting and reformatting system of claim 13, further comprising a graphical user interface permitting a user of the system to define the conditional logic statements utilized by the rerouting and reformatting application.

15. The electronic mail rerouting and reformatting system of claim 14, wherein the rerouting and reformatting application further comprises a parsing function, parsing the information contained within the electronic mail message into a plurality of individual nodes representing items of data contained within the message.

16. The electronic mail and rerouting and reformatting system of claim 15 wherein the rerouting and reformatting application examines the individual nodes produced by the parsing function to determine an association between the electronic mail message and a conditional logic statement indicating an additional destination for information contained within the electronic mail message.

17. A method of rerouting and reformatting an electronic mail message, comprising the steps of:
receiving an electronic mail message in a first format intended for a first destination;
associating information contained within the message with a second destination;
evaluating compatibility of the first format with a receiving format desired by the second destination; and
reformatting the information contained within the electronic mail message into a second format that is compatible with the receiving format of the second destination.

18. The method of claim 17, further comprising the steps of:
parsing the electronic mail message into a plurality of nodes representing data; and
examining respective nodes for data that indicates a need to perform at least one of (a) reformatting and (b) rerouting of the information contained within the electronic mail message.

19. The method of claim 18, further comprising the steps of:
alerting a user as to the absence of a second destination associated with information contained within the message; and
discarding the electronic mail message.
